(19) United States
(12) Patent Application Publication
(10) Pub. No.: US 2013/0322894 A1
(43) Pub. Date: Dec. 5, 2013

(54) Image Forming Apparatus Capable of Reliably Detecting Movement of Passage Defining Assembly

(71) Applicants: Kei Ishida, Nagoya-shi (JP); Hisashi Tsukawaki, Nagoya-shi (JP)

(72) Inventors: Kei Ishida, Nagoya-shi (JP); Hisashi Tsukawaki, Nagoya-shi (JP)

(21) Appl. No.: 13/738,011

(22) Filed: Jan. 10, 2013

(30) Foreign Application Priority Data
May 31, 2012 (JP) 2012-124425

(51) Int. Cl. G03G 15/00

(52) U.S. Cl. CPC G03G 15/70
USPC 399/21

(57) ABSTRACT

An image forming apparatus including: a passage defining assembly; a movable member; an assisting member; and a sensor. The passage defining assembly defines a conveying passage. The passage defining assembly is pivotally movable relative to the main casing between a first position for defining the conveying passage and a second position for expanding the conveying passage in size greater than that at the first position. The movable member is positioned to intersect the conveying passage and is pivotally movably supported to the passage defining assembly. The assisting member is configured to abut the movable member when the passage defining assembly is moved from the first position to the second position to allow the movable member to pivotally move relative to the passage defining assembly. The sensor detects whether the movable member is pivotally moved.

### CROSS REFERENCE TO RELATED APPLICATION

This application claims priority from Japanese Patent Application No. 2012-124425 filed May 31, 2012. The entire content of the priority application is incorporated herein by reference.

1. Technical Field

The present invention relates to an image forming apparatus provided with a fixing device for thermally fixing a developer image on a recording sheet and a passage defining assembly for defining a sheet conveying passage at a downstream side of the fixing device in a conveying direction of the recording sheet.

2. Background

There is known a conventional image forming apparatus including a main frame, a fixing device, a rear chute (passage defining assembly) that defines a sheet conveying passage at a downstream side of the fixing device and that is pivotally movable with respect to the main frame, a movable member that is pivotally movably provided at the rear chute and that protrudes toward the sheet conveying passage, and a sensor that is provided in the main frame and that detects the movable member. At the time of a printing operation, in this conventional image forming apparatus, a sheet contacts the movable member to cause a pivotal movement of the movable member. The sensor thus detects a sheet feeding state. Further, when fixing a sheet jam, the rear chute is pivotally moved so as to open the sheet conveying passage. Since the movable member moves integrally with the rear chute, the movable member moves away from the sensor. Thus, the sensor detects a released state of the rear chute.

### SUMMARY

However, the above conventional technique can only allow the rear chute and the movable member to move together, so that when the rear chute is pivotally moved by a small amount so as to open the sheet conveying passage, an amount of movement of the movable member becomes small at the released state of the rear chute, with the result that the movable member does not sufficiently move away from the sensor, thus resulting in failing to switch a detection state of the sensor.

In view of the foregoing, it is an object of the present invention to provide an image forming apparatus capable of reliably switching a detection state of a sensor even with a small amount of pivotal movement of the rear chute (passage defining assembly).

In order to attain the above and other objects, the present invention provides an image forming apparatus including: a main casing; a first fixing member; a second fixing member; a passage defining assembly; a movable member; an assisting member; and a sensor. The second fixing member is configured to provide a nip region in cooperation with the first fixing member for thermally fixing a developer agent image on a recording sheet conveyed in a conveying direction. The passage defining assembly is configured to define a conveying passage through which the recording sheet is conveyed. The conveying passage is positioned downstream of the first fixing member and the second fixing member in the conveying direction. The passage defining assembly is also configured to be pivotally movable relative to the main casing between a first position for defining the conveying passage and a second position for expanding the conveying passage in size greater than that at the first position. The movable member is positioned to intersect the conveying passage and configured to be pivotally movably supported to the passage defining assembly. The assisting member is provided at the main casing. The assisting member is configured to abut the movable member when the passage defining assembly is moved from the first position to the second position to allow the movable member to pivotally move relative to the passage defining assembly. The sensor is provided at the main casing and configured to detect whether the movable member is pivotally moved.

According to another aspect, the present invention provides an image forming apparatus including: a main casing; a first fixing member; a second fixing member; a fixing frame; a passage defining assembly; a movable member; an assisting member; and a sensor. The second fixing member is configured to provide a nip region in cooperation with the first fixing member for thermally fixing a developer agent image on a recording sheet conveyed in a conveying direction. The fixing frame is configured to support the first fixing member and the second fixing member. The fixing frame has a conveyor surface. The passage defining assembly has a defining surface and configured to be pivotally movable relative to the main casing between a first position and a second position. The defining surface is configured to define the conveying passage through which the recording sheet is conveyed in cooperation with the conveyor surface when the passage defining assembly is at the first position. The conveying passage is positioned downstream of the first fixing member and the second fixing member in the conveying direction. The defining surface is also configured to be moved away from the conveyor surface in a frontward/rearward direction and in a vertical direction to expand the conveying passage when the passage defining assembly is moved from the first position to the second position. The movable member is positioned to intersect the conveying passage and configured to be pivotally movably supported to the passage defining assembly. The assisting member is provided at the main casing. The assisting member is configured to abut the movable member when the passage defining assembly is moved from the first position to the second position to allow the movable member to pivotally move relative to the passage defining assembly. The sensor is provided at the main casing and configured to detect whether the movable member is pivotally moved.

### BRIEF DESCRIPTION OF THE DRAWINGS

In the drawings:

FIG. 1 is a schematic cross-sectional view showing a structure of a laser printer according to one embodiment of the present invention;

FIG. 2 is a cross-sectional view of a fixing device provided in the laser printer according to the embodiment;

FIG. 3 is a cross-sectional view of components of the laser printer around the fixing device according to the embodiment;

FIG. 4 is a cross-sectional view showing a state where a first rear chute provided in the laser printer is opened according to the embodiment;

FIG. 5 is a schematic perspective view of an optical sensor provided in the laser printer according to the embodiment;

FIGS. 6A and 6B are views showing a movable member provided in the laser printer according to the embodiment, in which FIG. 6A shows a state where a sheet is about to contact the movable member and FIG. 6B shows a state where a sheet has contacted the movable member;

FIG. 7 is a top plan view of a fixing frame and a support frame provided in the laser printer according to the embodiment; and

FIG. 8 is a rear side view of the fixing frame and the support frame in the laser printer according to the embodiment.

### DETAILED DESCRIPTION

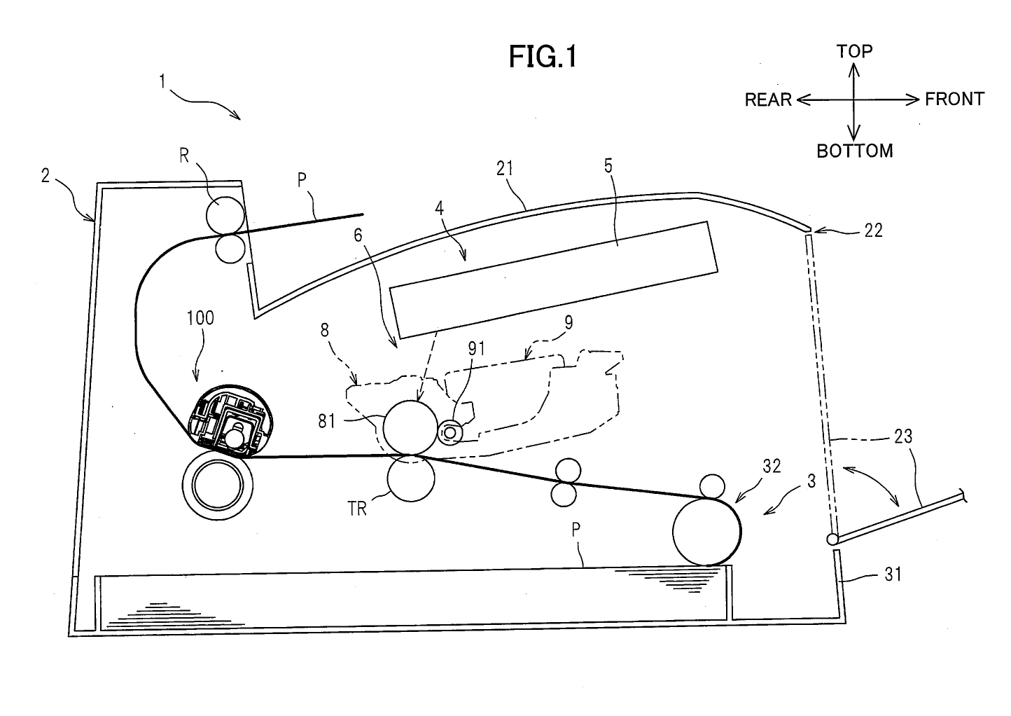

Next, a general structure of a laser printer 1 as an image forming apparatus according to one embodiment of the present invention will be described with reference to FIGS. 1 through 8.

Throughout the specification, the terms “upward”, “downward”, “upper”, “lower”, “above”, “below”, “beneath”, “right”, “left”, “front”, “rear” and the like will be used assuming that the laser printer 1 is disposed in an orientation in which it is intended to be used. More specifically, in FIG. 1 a right side and a left side are a front side and a rear side, respectively. Further, in FIG. 1 a near side and a far side are a left side and a right side.

### Overall Structure of Laser Printer

As shown in FIG. 1, the laser printer 1 includes a main frame 2, a feeder unit 3, and an image forming unit 4. The feeder unit 3 and the image forming unit 4 are provided in the main frame 2. The feeder unit 3 is adapted to supply a sheet P to the image forming unit 4. The image forming unit 4 is adapted to form an image on the sheet P.

The main frame 2 includes a support frame 24. Further, the main frame 2 has a front wall formed with a front opening 22 which is opened or closed by a front cover 23. The front cover 23 is pivotally movably supported to the front wall of the main frame 2. Further, the main frame 2 has a rear wall formed with a rear opening (not shown) which is opened or closed by a rear cover 25. The rear cover 25 is pivotally movably supported to the rear wall of the main frame 2.

The feeder unit 3 includes a sheet supply tray 31 and a sheet supplying mechanism 32. The sheet supply tray 31 is detachably mounted in a lower inner portion of the main frame 2 and accommodates the sheet P therein. The sheet supplying mechanism 32 is adapted to supply the sheet P accommodated in the sheet supply tray 31 to the image forming unit 4.

The image forming unit 4 includes a scanner unit 5, a process cartridge 6, a transfer roller TR, and a fixing device 100.

The scanner unit 5 is provided at an upper inner portion of the main frame 2. The scanner unit 5 includes a laser beam emitting portion (not shown), a polygon mirror (not shown), lenses (not shown), and a reflection mirror (not shown). In the scanner unit 5, a laser beam is subjected to high speed scanning on an outer peripheral surface of a photosensitive drum 81 (described later) for exposing the surface to the laser beam.

The process cartridge 6 can be removed from and attached to the main frame 2 through the front opening 22 upon opening the front cover 23. The process cartridge 6 includes a drum cartridge 8 and a developing cartridge 9.

The drum cartridge 8 includes the photosensitive drum 81 whose outer peripheral surface carries an electrostatic latent image, and a charger (not shown).

The developing cartridge 9 is configured to be detached from and attached to the drum cartridge 8. The developing cartridge 9 includes a developing roller 91, a toner supply roller (not shown), a toner thickness regulation blade (not shown), and an agitator (not shown). The developing roller 91 is adapted to supply toner (developer agent) accommodated in an internal space of the developing cartridge 9 to the photosensitive drum 81.

In the process cartridge 6, after the outer peripheral surface of the photosensitive drum 81 has been uniformly charged by the charger (not shown), the surface is exposed to laser beam scanning by the scanner unit 5 at high speed, thereby reducing an electric potential at an exposed portion of the surface. The electrostatic latent image corresponding to image data is thus formed on the surface of the photosensitive drum 81.

The toner accommodated in the developing cartridge 9 is then supplied to the electrostatic latent image formed on the surface of the photosensitive drum 81 through the rotationally driven developing roller 91, so that a toner image is formed on the surface of the photosensitive drum 81. While the sheet P passes between the photosensitive drum 81 and the transfer roller TR, the toner image carried on the surface of the photosensitive drum 81 is transferred onto the sheet P.

The fixing device 100 is positioned rearward of the process cartridge 6.

The toner image transferred onto the sheet P is thermally fixed to the sheet P upon passing through the fixing device 100. Then, the sheet P is discharged onto a discharge tray 21 by conveyor rollers R.

### Detailed Structure of Fixing Device

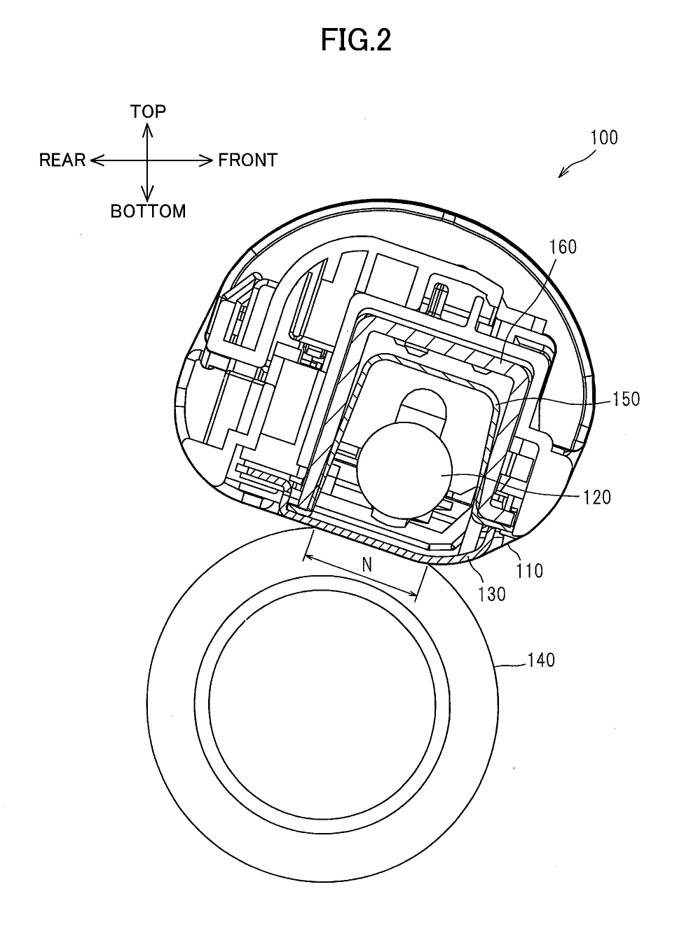

As shown in FIG. 2, the fixing device 100 includes a fusing belt 110, a halogen lamp 120, a nip plate 130, a pressure roller 140, a reflection plate 150, and a stay 160.

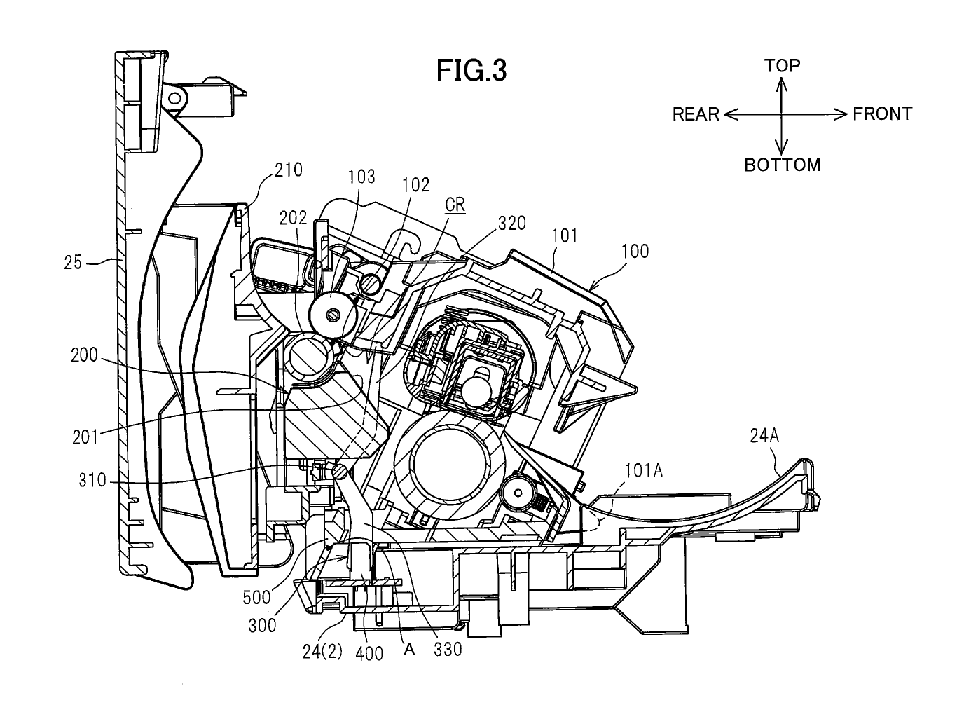

Further, as shown in FIG. 3, the fixing device 100 further includes a fixing frame 101 constituting a casing of the fixing device 100. The fusing belt 110, the halogen lamp 120, the nip plate 130, the pressure roller 140, the reflection plate 150 and the stay 160 are supported to the fixing frame 101. The fixing frame 101 has a conveyor surface 102. A conveyor roller 103 is rotatably supported to the fixing frame 101.

The fusing belt 110 is a tubular endless belt having heat resistivity and flexibility. The fusing belt 110 is formed of a stainless steel, for example. Circular movement of the fusing belt 110 is guided by guide members (not shown) fixed to the fixing frame 101.

The halogen lamp 120 is adapted to generate radiant heat for heating the nip plate 130 and the fusing belt 110 (a nip region N) to heat the toner on the sheet P.

The halogen lamp 120 is positioned in an internal space defined by the fusing belt 110. The halogen lamp 120 is spaced away from an inner peripheral surface of the fusing belt 110 and away from an inner surface of the nip plate 130 by a predetermined distance.

The nip plate 130 is adapted to receive the radiant heat from the halogen lamp 120 and formed in a plate-like shape. The nip plate 130 is positioned in the internal space of the fusing belt 110, and has a lower surface with which the inner peripheral surface of the fusing belt 110 is slidably moved. In the depicted embodiment, the nip plate 130 is made from a metallic material, such as, aluminum having heat conductivity higher than that of the stay 160 made from steel. An aluminum plate is bent into a generally U-shape for fabricating the nip plate 130. The nip plate 130 made from aluminum is capable of enhancing its heat conductivity.

The pressure roller 140 is positioned below the nip plate 130 and is adapted to nip the fusing film 110 in cooperation with the nip plate 130 to provide the nip region N. In the depicted embodiment, to provide the nip region N between the pressure roller 140 and the fusing belt 110, one of the nip plate 130 and the pressure roller 140 is urged toward a remaining one of the nip plate 130 and the pressure roller 140. Upon rotation of the pressure roller 140 while nipping the fusing belt 110 in cooperation with the nip plate 130, the fusing belt 110 is circularly moved. The sheet P is thus conveyed rearward.

The pressure roller 140 is rotationally driven by a drive force transmitted from a motor (not shown) provided in the main frame 2 through a power transmission mechanism (not shown). Upon rotation of the pressure roller 140, the fusing belt 110 is driven by way of a friction force generated therebetween or through the sheet P. The sheet P carrying a toner image passes through a position between the pressure roller 140 and the heated fusing belt 110 (the nip region N), whereupon the toner image is thermally fixed onto the sheet P.

The reflection plate 150 has a generally U-shaped cross-section for reflecting the radiant heat from the halogen lamp 120 to the nip plate 130. The reflection plate 150 is positioned in the internal space of the fusing belt 110, and spaced away from the halogen lamp 120 by a predetermined distance so as to surround the halogen lamp 120.

The stay 160 is adapted to support the nip plate 130 through the reflection plate 150 to receive a force acting from the pressure roller 140. The stay 160 is positioned in the internal space of the fusing belt 110 so as to cover the halogen lamp 120 and the reflection plate 150. The stay 160 is made from a material having high rigidity such as steel. A steel plate is bent into a generally U-shape for fabricating the stay 160.

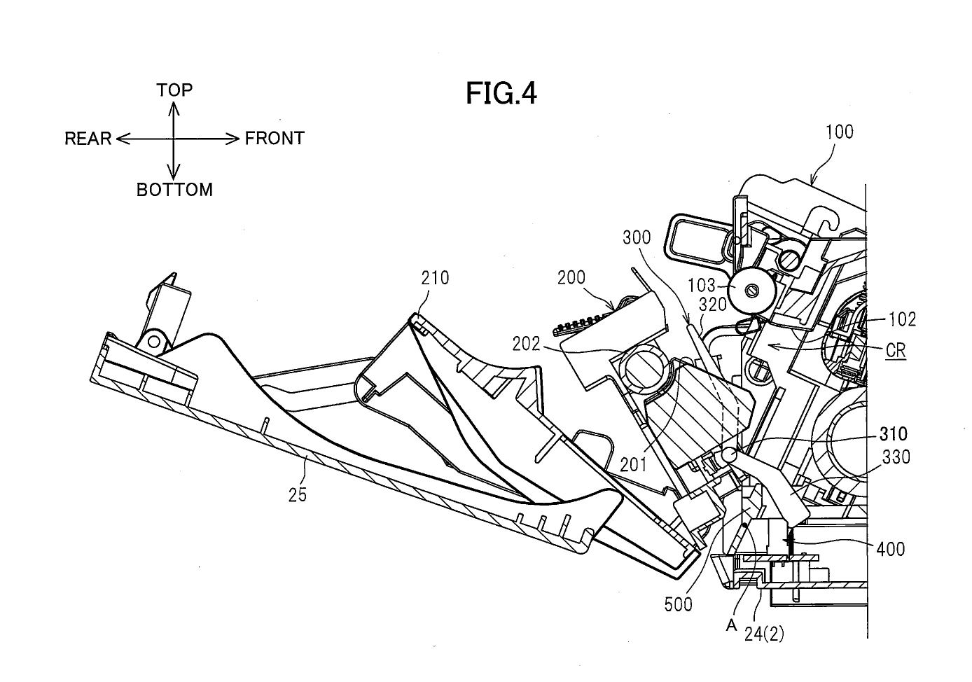

As shown in FIGS. 3 and 4, the laser printer 1 further includes a first rear chute 200, a second rear chute 210, a movable member 300, and an optical sensor 400, each positioned at a rear side of the fixing device 100. That is, the first rear chute 200, the second rear chute 210, the movable member 300, and the optical sensor 400 are positioned downstream of the fixing device 100 in a conveying direction of the sheet P.

The first rear chute 200 has a conveyor surface 201 and includes a conveyor roller 202. The conveyor surface 201 is positioned rearward of the nip region N. The conveyor surface 201 is a slant surface extending diagonally upward and rearward. The conveyor surface 201 defines a sheet conveying passage CR for the sheet P in cooperation with the conveyor surface 102 of the fixing frame 101.

The conveyor roller 202 is positioned adjacent to an upper end portion of the conveyor surface 201. The conveyor roller 202 is rotatably supported to the first rear chute 200. The conveyor roller 202 conveys the sheet P while nipping the sheet P in cooperation with the conveyor roller 103.

The first rear chute 200 has a lower end portion pivotally movably supported to the main frame 2. In other words, the first rear chute 200 is pivotally movable relative to the main frame 2 about a pivot axis A (shown in FIGS. 3 and 4). Thus, the first rear chute 200 is movable between a first position (shown in FIG. 3) for defining the sheet conveying passage CR and a second position (shown in FIG. 4) for expanding the sheet conveying passage CR in size greater than that at the first position. That is, when the first rear chute 200 is at the second position, the sheet conveying path CR has a dimension in a thickness direction of the sheet P greater than that at the first position. More specifically, when the first rear chute 200 is moved from the first position to the second position, the conveyor surface 201 and the conveyor roller 202 of the first rear chute 200 are pivotally moved rearward such that the conveyor roller 202 is separated from the conveyor roller 103 diagonally rearward and downward and such that a gap between the conveyor surface 102 and the conveyor surface 201 is enlarged in the frontward/rearward direction and in the vertical direction.

With this configuration, even if the sheet P is jammed at a position between the conveyor roller 103 and the conveyor roller 202 or within the sheet conveying passage CR, the jammed sheet P can be removed therefrom by opening the first rear chute 200 (i.e. by moving the first rear chute 200 to the second position) to move the conveyor roller 202 away from the conveyor roller 103 and to move the conveyor surface 201 away from the conveyor surface 102.

The second rear chute 210 is supported to the main frame 2, and configured to form a conveying passage of the sheet P downstream of the conveyor roller 103 and the conveyor roller 202 in the sheet conveying direction. The second rear chute 210 and the rear cover 25 are positioned rearward of the first rear chute 200. Both the second rear chute 210 and the rear cover 25 are pivotally movable relative to the main frame 2.

The rear cover 25, the second rear chute 210, and the first rear chute 200 are aligned in a frontward/rearward direction in this order from rear to front in a state where the rear cover 25 is closed the rear opening of the main frame 2. The rear cover 25 has a first angle relative to a horizontal plane when the rear cover 25 is pivotally moved relative to the main frame 2 at a maximum in a direction opening the rear opening, and the second rear chute 210 has a second angle relative to the horizontal plane when the second rear chute 210 is pivotally moved relative to the main frame 2 at a maximum in the direction, and the first rear chute 200 has a third angle relative to the horizontal plane when the first rear chute 200 is pivotally moved relative to the main frame 2 at a maximum in the direction. The third angle is greater than the second angle, and the second angle is greater than the first angle. In other words, the foremost pivotally movable component (i.e. the first rear chute 200) has the greatest angle relative to the horizontal plane at the maximally pivotally moved state, and the rearmost pivotally movable component (i.e. the rear cover 25) has the smallest angle relative to the horizontal plane at the maximally pivotally moved state. That is, the first rear chute 200 has a pivotally movable amount smaller than that of the rear cover 25 and also smaller than that of the second rear chute 210.

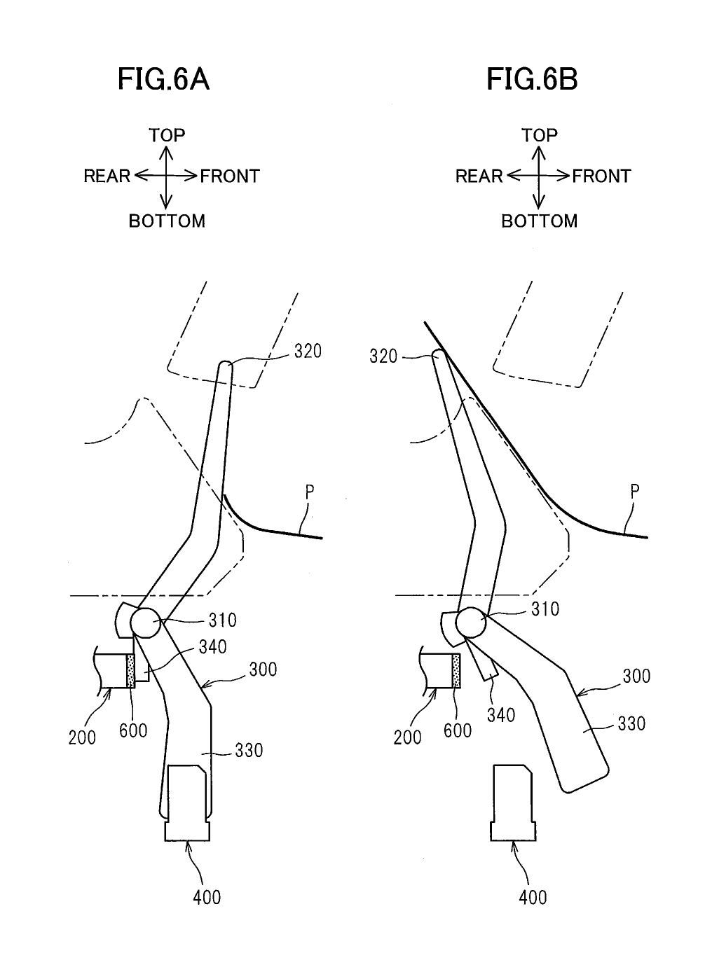

The movable member 300 is positioned so as to intersect the sheet conveying passage CR. The movable member 300 is supported to the first rear chute 200 and pivotally movable relative to the first rear chute 200. More specifically, the movable member 300 includes a pivot shaft 310, a first extending portion 320, a second extending portion 330, and an abutment portion 340 (FIGS. 6A and 6B).

The pivot shaft 310 is rotatably supported to the first rear chute 200.

The first extending portion 320 extends from the pivot shaft 310 toward the sheet conveying passage CR. The first extending portion 320 is bent into generally V-shape, extending diagonally frontward and upward from the pivot shaft 310 and then extending upward, when the first rear chute 200 is at the first position.

The second extending portion 330 extends from the pivot shaft 310 toward the optical sensor 400 (described later). The second extending portion 330 is bent into generally V-shape, extending diagonally frontward and downward from the pivot shaft 310 and then extending downward, when the first rear chute 200 is at the first position.

The movable member 300 is connected to an urging member (not shown) such as a spring, and normally urged in a clockwise direction in FIG. 3 by the urging member. Instead of the urging member, the movable member 300 may be urged in the clockwise direction in FIG. 3 by its own weight.

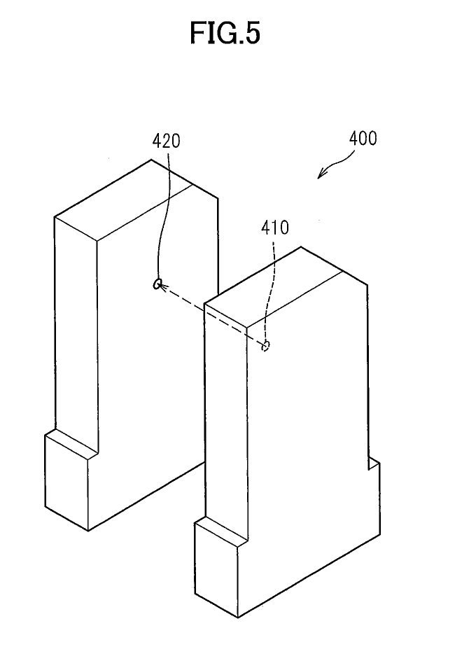

The optical sensor 400 is configured to detect whether the movable member 300 is pivotally moved. As shown in FIG. 3, the optical sensor 400 is provided in the main frame 2. More specifically, the optical sensor 400 is provided at the support frame 24 constituting the main frame 2. Further, as shown in FIG. 5, the optical sensor 400 includes a light emitting portion 410 for emitting a detection light and a light receiving portion 420 for receiving the detection light emitted from the light emitting portion 410. When the first rear chute 200 is at the first position, a lower end portion of the second extending portion 330 of the movable member 300 is positioned between the light emitting portion 410 and the light receiving portion 420.

The movable member 300 and the optical sensor 400 are thus configured, so that, in a state shown in FIG. 3, when the sheet P is discharged from the nip region N of the fixing device 100, as shown in FIGS. 6A and 6B, the first extending portion 320 of the movable member 300 is pushed rearward by a leading end of the sheet P. As a result, the movable member 300 is pivotally moved in a counterclockwise direction in FIGS. 6A and 6B, which causes the second extending portion 330 of the movable member 300 to be moved away from the optical sensor 400. More specifically, at this time, the second extending portion 330 is pivotally moved diagonally upward and frontward and retracted from a gap between the light emitting portion 410 and the light receiving portion 420. Thus, the optical sensor 400 can detect passage of the sheet P in the sheet conveying passage CR.

Further, as shown in FIGS. 3 and 4, when the first rear chute 200 is pivotally moved rearward (i.e. moved from the first position to the second position), the movable member 300 is pivotally moved about the pivot axis A of the first rear chute 200. Incidentally, the pivot axis A of the first rear chute 200 is positioned downward of the pivot shaft 310 of the movable member 300. In this case as well, the second extending portion 330 is moved away from the optical sensor 400. Thus, the optical sensor 400 can also detect whether the first rear chute 200 is at the first position or at the second position. The optical sensor 400 distinguishes the movement of the first rear chute 200 from the passage of the sheet P based on a length of time the second extending portion 330 is away from the optical sensor 400.

In this configuration, when the first rear chute 200 is pivotally moved by a small amount, there may occur, due to production errors of respective components constituting the laser printer 1, for example, a case where the movable member 300 is not moved away from the optical sensor 400.

To solve this problem, in the depicted embodiment, the laser printer 1 further includes an assisting member 500 adapted to reliably move the movable member 300 away from the optical sensor 400 when the first rear chute 200 is pivotally moved from the first position to the second position. The assisting member 500 is disposed rearward of the second extending portion 330 of the movable member 300 and formed so as to protrude diagonally upward and frontward from the support frame 24 supporting the fixing frame 101 of the fixing device 100. The assisting member 500 is adapted to be abuttable on the second extending portion 330 of the movable member 300 when the first rear chute 200 is pivotally moved from the first position to the second position, and abutment of the assisting member 500 on the second extending portion 330 pivotally moves the movable member 300 relative to the first rear chute 200. Pivotal movement of the movable member 300 by means of the assisting member 500 switches a detection state of the optical sensor 400. That is, the movable member 300 is moved away from the optical sensor 400 as a result of abutment of the assisting member 500 on the second extending portion 330 of the movable member 300, so that the optical sensor 400 can detect that the first rear chute 200 has been moved from the first position to the second position.

With this configuration, when the first rear chute 200 is pivotally moved from the first position to the second position, the assisting member 500 is brought into abutment with the second extending portion 330 of the movable member 300. As a result, the movable member 300 is pivotally moved relative to the first rear chute 200. Hence, the assisting member 500 allows the movable member 300 to pivotally move in an amount sufficient to switch the detection state of optical sensor 400.

Thus, even if the first rear chute 200 is pivotally moved only by a small amount, the movable member 300 can be pivotally moved to an extent such that the second extending portion 330 is moved away from the optical sensor 400. Accordingly, the detection state of the optical sensor 400 can be reliably switched.

Further, in the depicted embodiment, the assisting member 500 is abuttable on the second extending portion 330 of the movable member 300. Compared to a case, for example, where the assisting member 500 is abuttable on the first extending portion 320, this configuration prevents the assisting member 500 from disturbing conveyance of the sheet P.

Further, as shown in FIGS. 6A and 6B, the first rear chute 200 is provided with a sponge 600. More specifically, the sponge 600 is adapted to restrict a pivotal movement of the movable member 300 in a clockwise direction in FIGS. 6A and 6B when the first rear chute 200 is at the first position. That is, the sponge 600 is provided so as to restrict the movable member 300 from pivotally moving in a direction opposite to the direction in which the movable member 300 is pivotally moved by contact with the sheet P conveyed through the sheet conveying passage CR when the first rear chute 200 is at the first position. The sponge 600 is disposed at a position such that the abutment portion 340 of the movable member 300 is abuttable on the sponge 600.

The abutment portion 340 is formed so as to extend downward (in a direction the same as an extending direction of the second extending portion 330) from the pivot shaft 310 when the first rear chute 200 is in the first position. When the movable member 300 returns to its original position (FIG. 6A) after being pivotally moved by contacting the sheet P, the abutment portion 340 of the movable member 300 is brought into abutment with the sponge 600. Thus, the sponge 600 can absorb an impact at the time of abutment of the abutment portion 340 on the sponge 600, and also reduce a noise caused by abutment of the abutment portion 340 on the sponge 600.

However, aging degradation or production error of the sponge 600 may increase an advancing amount of the abutment portion 340 toward the sponge 600, which displaces the position of the movable member 300 relative to the optical sensor 400. This may result in failing to switch the detection state of the optical sensor 400 when the first rear chute 200 is moved from the first position to the second position.

To prevent such a situation, in the depicted embodiment, the assisting member 500 is provided to reliably pivotally move the movable member 300 when the first rear chute 200 is moved from the first position to the second position regardless of displacement of the position of the movable member 300 relative to the optical sensor 400 due to degradation of the sponge 600. Hence, the detection state of the optical sensor 400 can be reliably switched.

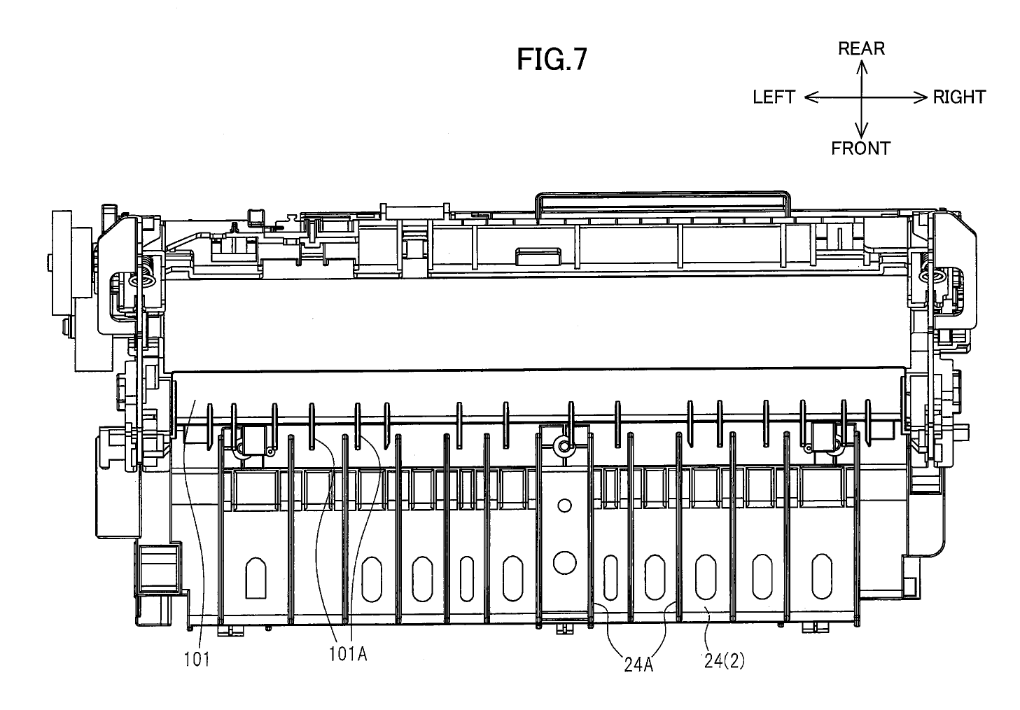

Further, as shown in FIGS. 3 and 7, the support frame 24 supporting the fixing frame 101 from below has a front portion provided with a plurality of main frame side conveyor ribs 24A. The plurality of conveyor ribs 24A protrudes upward from the front portion, and is arranged spaced apart from each other in a rightward/leftward direction. Further, the fixing frame 101 has a front lower portion provided with plurality of fixing frame side conveyor ribs 101A. The plurality of conveyor ribs 101A protrudes frontward from the front lower portion and is spaced apart from each other in the rightward/leftward direction.

The conveyor ribs 24A and the conveyor ribs 101A are assembled so as to overlap each other as viewed in the rightward/leftward direction. In other words, the conveyor ribs 101A are positioned so as to be fitted in gaps between the conveyor ribs 24A. However, with this configuration, if the fixing frame 101 is inclined rightward or leftward when assembling the fixing frame 101 to the support frame 24, the conveyor ribs 24A and the conveyor ribs 101A interfere with each other, which may cause damages to the conveyor ribs 24A and the conveyor ribs 101A.

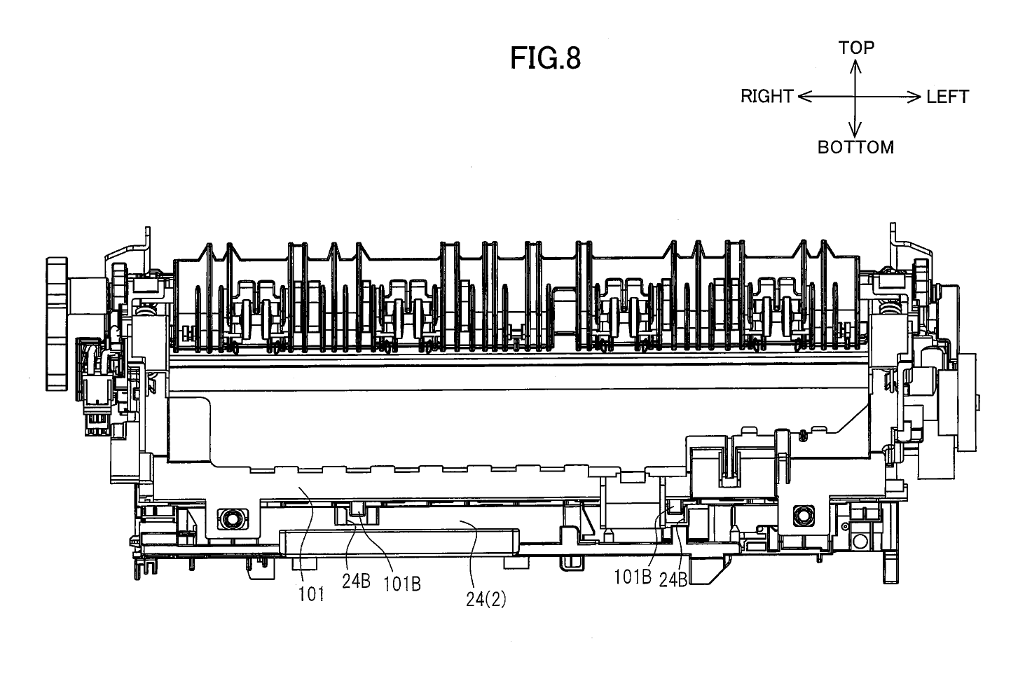

For this reason, in the depicted embodiment, as shown in FIG. 8, the fixing frame 101 has a lower surface at which a right and left pair of guide ribs 101B is provided. Each of the guide ribs 101B protrudes downward from the lower surface of the fixing frame 101 and extends in the frontward/rearward direction. Further, the support frame 24 is formed with a right and left pair of recesses 24B for guiding the guide ribs 101B. The recesses 24B are positioned rearward of the conveyor ribs 24A. When assembling the fixing frame 101 to the support frame 24, this configuration allows the fixing frame 101 to be slidingly moved toward the conveyor ribs 24A along the pair of recesses 24B while inserting the pair of guide ribs 101B into the pair of recesses 24B respectively. Hence, inclination of the fixing frame 101 can be restrained, and therefore, damages to the conveyor ribs 24A and the conveyor ribs 101A can be prevented.

Various variations and modifications are conceivable.

In the above-described embodiment, the assisting member 500 is directly provided at the main frame 2 (the support frame 24). However, the assisting member 500 may be indirectly provided at the main frame 2 through any parts. For example, the assisting member 500 may be provided at the fixing frame 101.

In the above-described embodiment, the first rear chute 200 is provided at main frame 2 (support frame 24). However, the first rear chute 200 only needs to be pivotally movable relative to the main frame 2. For example, the first rear chute 200 may be provided at the fixing frame 101.

Further, the sheet P can be an OHP sheet instead of heavy paper, a postcard, and thin paper.

Further, in the above-described embodiment, the nip plate 130 is provided as the first fixing member, and the pressure roller 140 is provided as the second fixing member. However, a belt-like backup member can be used as the first fixing member, and a cylindrical heat roller can be used as the second fixing member.

Further, in the above-described embodiment, the sensor is the optical sensor. However, a pressure sensor or a magnetic sensor is also available.

Further, in the above-described embodiment, the impact absorbing member is the sponge 600. However, a rubber or a felt is also available.

Further, in the above-described embodiment, the image forming apparatus is the laser printer. However, other types of image forming apparatus, such as a copying machine and a multifunction device are also available.

While the invention has been described in detail with reference to the embodiment thereof, it would be apparent to those skilled in the art that various changes and modifications may be made therein without departing from the spirit of the invention.

What is claimed is:

1. An image forming apparatus comprising:
a main casing;
a first fixing member;
a second fixing member configured to provide a nip region in cooperation with the first fixing member for thermally fixing a developer agent image on a recording sheet conveyed in a conveying direction;
a passage defining assembly configured to define a conveying passage through which the recording sheet is conveyed, the conveying passage being positioned downstream of the first fixing member and the second fixing member in the conveying direction, the passage defining assembly being also configured to be pivotally movable relative to the main casing between a first position for defining the conveying passage and a second position for expanding the conveying passage in size greater than that at the first position;
a movable member positioned to intersect the conveying passage and configured to be pivotally movably supported to the passage defining assembly;
an assisting member provided at the main casing, the assisting member being configured to abut the movable member when the passage defining assembly is moved from the first position to the second position to allow the movable member to pivotally move relative to the passage defining assembly; and
a sensor provided at the main casing and configured to detect whether the movable member is pivotally moved.

2. The image forming apparatus as claimed in claim 1, wherein the sensor also being configured to detect whether the passage defining assembly has been moved from the first position to the second position in association with the pivotal movement of the movable member by means of the assisting member.

3. The image forming apparatus as claimed in claim 1, wherein the passage defining assembly includes an impact absorbing member;
wherein the movable member is configured to be contacted with the recording sheet passing through the conveying passage to be pivotally moved in a predetermined direction; and
wherein the impact absorbing member is configured to restrict the movable member from pivotally moving in a direction opposite to the predetermined direction when the passage defining assembly is in the first position.

4. The image forming apparatus as claimed in claim 1, wherein the movable member comprises:
a pivot shaft configured to be rotatably supported to the passage defining assembly;
a first extending portion extending from the pivot shaft toward the conveying passage; and
a second extending portion extending from the pivot shaft toward the sensor, wherein the assisting member being configured to abut the second extending portion.

5. The image forming apparatus as claimed in claim 1, wherein the sensor comprises:
a light emitting unit configured to emit a light; and
a light receiving unit configured to receive the light emitted from the light emitting unit.

6. The image forming apparatus as claimed in claim 1, wherein when the passage defining assembly is at the second position, the conveying passage has a dimension in a thickness direction of the sheet greater than that at the first position.

7. An image forming apparatus comprising:
a main casing;
a first fixing member;
a second fixing member configured to provide a nip region in cooperation with the first fixing member for thermally fixing a developer agent image on a recording sheet conveyed in a conveying direction;
a fixing frame configured to support the first fixing member and the second fixing member, the fixing frame having a conveyor surface;
a passage defining assembly having a defining surface and configured to be pivotally movable relative to the main casing between a first position and a second position, the defining surface being configured to define the conveying passage through which the recording sheet is conveyed in cooperation with the conveyor surface when the passage defining assembly is at the first position, the conveying passage being positioned downstream of the first fixing member and the second fixing member in the conveying direction, the defining surface also being configured to be moved away from the conveyor surface in a frontward/rearward direction and in a vertical direction to expand the conveying passage when the passage defining assembly is moved from the first position to the second position;
a movable member positioned to intersect the conveying passage and configured to be pivotally movably supported to the passage defining assembly;
an assisting member provided at the main casing, the assisting member being configured to abut the movable member when the passage defining assembly is moved from the first position to the second position to allow the movable member to pivotally move relative to the passage defining assembly; and
a sensor provided at the main casing and configured to detect whether the movable member is pivotally moved.
